(19) United States
(12) Patent Application Publication
(10) Pub. No.: US 2007/0180783 A1
(43) Pub. Date: Aug. 9, 2007

(54) WINDOW FRAME WITH SELF-ALIGNING AND SELF-ATTACHING MEANS

(76) Inventor: Alejandro Amato, Mexico (MX)

Correspondence Address: CONNOLLY BOVE LODGE & HUTZ LLP, 1875 EYE STREET, N.W., SUITE 1100, WASHINGTON, DC, 20036, US

(21) Appl. No.: 11/425,311

(22) Filed: Jun. 20, 2006

Related U.S. Application Data
(60) Provisional application No. 60/691,556, filed on Jun. 20, 2005.

(51) Int. Cl. E06B 3/00

(52) U.S. Cl. 52/204.5

(57) ABSTRACT

A window frame with self-aligning and self-attaching means is disclosed. The Frame includes two interlocking frame members for securing the frame to a structure such as a door and for securing a window within the frame. The frame can be installed with no tools or screws and can be easily disassembled by inserting a nail into the frame and forcing the frame members apart.

This application claims the benefit of U.S. provisional patent application No. 60/691,556, field Jun. 20, 2005 and entitled “Window Frame with Self Aligning and Self Attaching Means.”

### BACKGROUND OF THE INVENTION

The invention relates to window frames for installation in a door, for example.

Known window frames require the final user to install several screws, depending on the size of the window, and then to cover the hole where the screws are installed with a plastic lid to mach the exposed frame surface. Both activities require labor with some level of skill, but the installation of the lids is particularly difficult due to the fact that, sometimes, the exposed surface where the hole of the screw has to be covered with the lid is uneven. Therefore, the correct application of the lid is almost entirely dependent on the operator's skill. In such cases, when the lid is incorrectly installed or removal of the frame is required, it is practically impossible to remove the lid without causing damage to the lid or the frame, creating great inconvenience.

In view of the above, it is desirable to provide an improved window frame that has multipurpose self-aligning and attaching means, so that the frame can be assembled to be securely transported to the final installation site, where it can be easily disassembled and finally installed in a door, for example. It is also desirable to provide such a frame that can be assembled without the utilization of any additional tools or hardware. such as screws, so as to minimize installation time, save materials and improve the appearance of the frame.

### SUMMARY OF THE INVENTION

The invention relates to a window frame that installs in less time and does not need customized tools, screws or complex installation lids. The window frame is easily disassembled as many times as required, without creating any damage to any of the frame components. The invention resolves the problems mentioned in the preceding background section, giving the final user and the intermediate assembler a simpler installation, thereby minimizing the skill and time required by the operator. Thus, the invention provides cost savings with respect to hourly labor rates and the total time required for intermediate assembly and installation.

According to one embodiment, of the invention, a window frame comprises:
at least one first frame member having a first arm, a second arm and a serrated tongue member; and
at least one second frame member having a third arm, a fourth arm and a receptacle having a serrated inner surface, wherein:
   said first arm and said third arm are arranged to cooperatively engage a portion of a structure therebetween;
   said second arm and said fourth arm are arranged to cooperatively engage a sheet of glass therebetween; and
   said serrated tongue member is insertable in said receptacle so as to engage said serrated inner surface of said receptacle in a locking fashion when said at least one first frame member and said at least one second frame member are pressed together to secure said sheet of glass in said door.

The disclosed window frame may further include a nail channel or nail hole in the second frame member which provides a pathway for inserting a similarly-sized nail in order to disassemble the frame. The disclosed window frame does not require screws or matching profile lids. Instead of conventional profile lids, a simple, reusable plastic pin is easily inserted in the channel to close the channel when the frame is in use.

A window with the present system of installation can typically be installed in 20% of the time required by conventional window frames for similar applications, as is evident from the disclosure in U.S. Pat. No. 5,644,881. The disclosed window frame can be removed from an installation in about 5% of the time required by conventional frames.

Other features and advantages will become apparent from the following description and drawings.

### BRIEF DESCRIPTION OF THE DRAWINGS

FIG. 1 is an exploded perspective view of a conventional window frame.

FIG. 2 is a cut-away perspective view showing the guiding system of the conventional assembly of FIG. 1.

FIG. 3 is a cut-away perspective view of a window frame according to one embodiment of the invention, wherein the window frame is in a position ready for final assembly.

FIG. 4 is a side sectional view of the window frame of FIG. 3 in a final assembled state.

FIG. 5 is a detailed view showing the self-attaching and self-aligning means of the window frame of FIG. 3.

### DETAILED DESCRIPTION

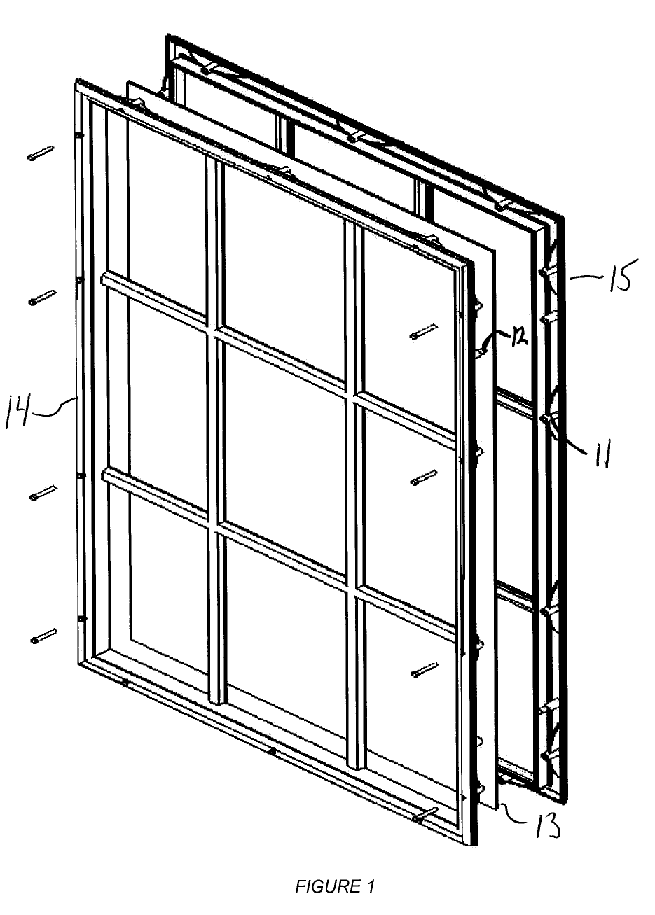

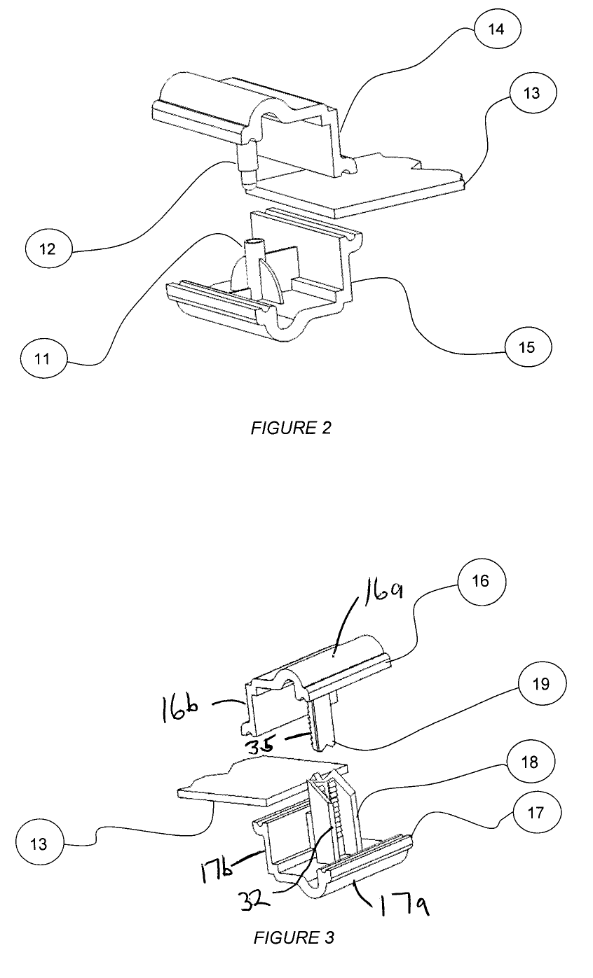

FIGS. 1 and 2 show a conventional window frame assembly which employs alignment pins for aligning frame pieces. The assembly includes a frame member 14 having male alignment pins 12 and a mating frame member 15 having female alignment pins 11. A sheet of glass 13 is secured within the frame members 14 and 15.

FIG. 3 shows an perspective view of a novel window frame 10, illustrating in detail the geometry of the self-aligning and self-attaching devices 18 and 19 which are used in place of the pins 11 and 12 of the conventional window frame shown in FIGS. 1 and 2, thereby avoiding the need for screws, lids and tools.

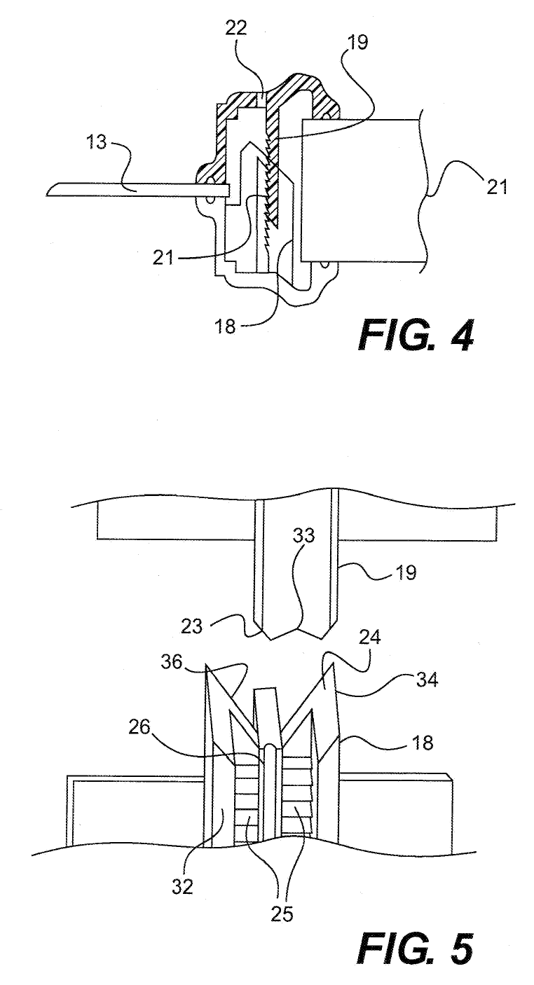

The frame 10 includes a first frame member 16 and a second frame member 17. The first frame member 16 has a first arm 16a for engaging a door or structure 20 (FIG. 4) and a second arm 16b for engaging a sheet of glass or window 13. Similarly, the second frame member 17 includes a first arm 17a for engaging the door or structure 20 and a second arm 17b for engaging a sheet of glass or window 13.

The first frame 16 member includes at least one flexible tongue member 19 that has a serrated geometry 35 on the attaching side. The second frame member 17 includes at least one self-aligning receptacle 18. The receptacle 18 serves two purposes. First, the receptacle 18 guides the frame member 17 to facilitate its installation on the door 20 (FIG. 4) by having a rib 32 with a suitable angle. Second, the receptacle interfaces with the tongue member 19 to facilitate the installation of the first frame member 16. The number of tongue members 19 and matching receptacles 18 used will depend upon the size of the frame.

The receptacle 18 is arranged to receive and cooperate with the tongue member 19 to lock the frame 10, thereby securing the arms 16a and 17a of frame members 16 and 17 to the door 20 and securing the sheet of glass or window 13 between the arms 16b and 17b of frame members 16 and 17. Referring to FIG. 5, the end portion of tongue 19 has suitable chamfers 23 on all surrounding edges. A receiving end 34 of the receptacle includes a V-shaped cutout 36 having an angled or chamfered top surface 24 matching the chamfers 23 of the tongue member 19, thereby promoting self-alignment of the tongue member 19 and receptacle 18 as the tongue member 19 is introduced into the receptacle 18. The receptacle 18 has a serrated inner surface 25 for engaging the serrated geometry 25 of the tongue member 19. As the serrated tongue member 19 is inserted forward into the receptacle 18, the serrated inner surface 38 engages the serrated geometry 25 in a locking fashion such that backwards movement of the tongue member 19 is prevented while forward advancement of the tongue member 19 into the receptacle 18 is easily permitted.

FIG. 4 shows the frame 10 installed on the door 20 and retaining the sheet of glass 13. Locking engagement between the serrated geometry 25 of the tongue member 19 and the serrated inner surface 38 of the receptacle 18 is indicated at interface 21.

Referring again to FIG. 5, the tongue member 19 includes a V-shaped notch 33 and chamfers provided on the edges of the notch 33 to facilitate guiding of a nail (not shown) for disassembling the fame 10. The receptacle 18 includes a recessed path or channel 26 for guiding the nail through the frame members 16 and 17 during disassembly. Access to the channel 26 is provided by a hole 22 extending through the first frame member 16. When the frame 10 is in use, the hole 22 may be plugged with a pin (not shown) of similar diameter (e.g., a reusable plastic pin of about 2 mm in diameter).

The installation of the frame 10 is extremely simple. The frame 10 may be installed in a structure or door or structure 20 by positioning one of the frame members 16 or 17 with the sheet of glass 13 over a previously removed section of the door or structure 20. The removed section of the door or structure should be similar in shape to the frame 10, but smaller in size. Once one of the frame members 16 or 17 is located in place, the door or structure 20 is placed on a supporting surface, such as a table, with the installed frame member 16 or 17 facing down. The remaining frame member 17 or 16 is positioned on the installed frame member 16 or 17 and pressure is applied with the installer's hands to insert the tongue member 19 into the receptacle 18 to the point that no further introduction is possible. Thus, the frame members 16 and 17 are locked together and secure the frame 10 and sheet of glass 13 to the door or structure 20.

To disassemble the frame, one needs to simply insert a nail into the channel 26 via hole 22 to separate the tongue member 19 from receptacle 18, thereby allowing the frame members 16 and 17 to be separated from each other.

### LISTING OF PARTS

11 Female alignment pin (conventional frame)
12 Male alignment pin (conventional frame)
13 Glass sheet
14 Upper frame member (conventional frame).
15 Lower frame member (conventional frame)
16 First frame member
16a First arm of first frame member
16b Second arm of first frame member
17 Second frame member
17a First arm of second frame member
17b Second arm of second frame member
18 Receptacle/alignment device
19 Serrated tongue member
20 Door or other mounting structure
21 Locking interface between serrated tongue member and receptacle
22 Hole to introduce the nail for disassembling the frame
23 Chamfer to facilitate the localization between tongue member and receptacle
24 Surrounding angulated surface to facilitate the localization between receptacle and tongue member
25 Serrated inner surface of receptacle
26 Depression channel to guide the nail to perform the disassembly
32 Rib of receptacle for aligning with door
33 V-shaped notch in tongue member
34 Receiving end of receptacle
35 Serrated geometry of tongue member
36 V-shaped cutout of receptacle
38 Serrated inner surface of receptacle

We claim:

1. A window frame comprising:
at least one first frame member having a first arm, a second arm and a serrated tongue member; and
at least one second frame member having a third arm, a fourth arm and a receptacle having a serrated inner surface, wherein:
said first arm and said third arm are arranged to cooperatively engage a portion of a structure therebetween;
said second arm and said fourth arm are arranged to cooperatively engage a sheet of glass therebetween; and
said serrated tongue member is insertable in said receptacle so as to engage said serrated inner surface of said receptacle in a locking fashion when said at least one first frame member and said at least one second frame member are pressed together to secure said sheet of glass in said door.

2. The window frame of claim 1, wherein said receptacle includes a channel arranged to receive a nail, wherein said serrated tongue member may be disengaged from said serrated inner surface of said receptacle upon being pushed by said nail, thereby allowing said at least one first frame member to be separated from said at least one second frame member.

3. The window frame of claim 2, wherein said end portion includes a V-shaped notch for assisting in guiding said nail in said recessed channel.

4. The window frame of claim 1, wherein said serrated tongue member includes a chamfered edges at an end portion thereof, and wherein said receptacle includes an angled cutout at a receiving end thereof, said chamfered edges and said angled cutout facilitating alignment of said serrated tongue member with said receptacle.
